(19) United States
(12) Patent Application Publication
(10) Pub. No.: US 2013/0183424 A1
(43) Pub. Date: Jul. 18, 2013

(54) AGGLOMERATES AND PREPARATION THEREOF

(71) Applicants: Joachim N.C. Baur, Newcastle (CA); Kenneth S. Darley, Ontario (CA); Luke P. Hazlett, Toronto (CA); John J. Prisciak, Pickering (CA); Jasna Turulja, Woodbridg (CA)

(72) Inventors: Joachim N.C. Baur, Newcastle (CA); Kenneth S. Darley, Ontario (CA); Luke P. Hazlett, Toronto (CA); John J. Prisciak, Pickering (CA); Jasna Turulja, Woodbridg (CA)

(73) Assignee: GRIFFITH LABORATORIES INTERNATIONAL, INC., Alsip, IL (US)

(21) Appl. No.: 13/784,927

(22) Filed: Mar. 5, 2013

Related U.S. Application Data
(62) Division of application No. 12/843,378, filed on Jul. 26, 2010.

(51) Int. Cl. A23L 1/00

(52) U.S. Cl. CPC A23L 1/0023
USPC 426/454

(57) ABSTRACT

Agglomerates of cereals are held together by a binding matrix, rather than sugars, and are formed by providing a dry mix of cereals in particular form, such as flakes, and starch-based matrix-forming material, optionally along with other components. These are then mixed with water to hydrate the binding matrix and allow it to swell to form a paste and to bind the bulk materials together. The resulting blend is extruded to an outlet using a relatively open or no die so that any back pressure and heat generated is sufficient to permit the matrix material to set and bind the particular cereal without excess heat. The agglomerate extruded from the extruder are cut into pieces of the desired size and dried to final desired moisture content.

### FIELD OF THE INVENTION

This application relates to the preparation of agglomerates and agglomerates produced thereby.

### BACKGROUND OF THE INVENTION

A variety of procedures have been described in the prior art for obtaining various food products using extrusion. A search of the prior art located the following references:

| US | U.S. Pat. No. | U.S. Pat. No. |
|---|---|---|
| 20060286270 | 3,600,193 | 3,753,729 |
| U.S. Pat. No. | U.S. Pat. No. | U.S. Pat. No. |
| 4,259,359 | 4,315,954 | 4,756,921 |
| U.S. Pat. No. | U.S. Pat. No. | U.S. Pat. No. |
| 4,837,112 | 5,097,017 | 6,419,972 |
| U.S. Pat. No. | U.S. Pat. No. | U.S. Pat. No. |
| 6,607,760 | 6,740,348 | 6,776,734 |
| U.S. Pat. No. | U.S. Pat. No. | GB 2111816 |
| 6,830,768 | 7,037,551 | |

However, none of these references discloses or suggests how to make agglomerates of a variety of cereals under the conditions described herein.

### SUMMARY OF THE INVENTION

In accordance with the present invention, there is provided a procedure for the preparation of agglomerates of cereals held by a binding matrix. The invention uses a combination of formulations and process conditions to produce a variety of agglomerates with varying textures by extrusion followed by drying, as described herein. The agglomerates produced thereby are a novel product and form another aspect of this invention.

The cereals from which the agglomerates may be made include wheat, oats, barley, corn, rice, rye, triticale, buckwheat, kamut, spelt, quinoa, amaranth, teff and einkom. The cereal-based agglomerates provided herein may include various combinations of grains, legumes, pulses, seeds, fruits and berries, vegetables, spices, coconut, nuts, prebiotics, cocoa and other flavouring agents.

These cereal-based agglomerates may be used in a variety of potential food applications, including toppers, crumbles or inclusions for dairy-based products, such as yogurts, ice cream and cream cheese; toppers or crumbles for desert items, such as pies, custards, cakes and cobblers; toppers, crumbles or inclusions for savoury items, such as pasta, salads, pizza or casseroles; granola or snack bar components; additions to ready-to-eat cereals; coatings for vegetable, fruit, dairy or other protein substrates; and as components of fruit and wet mixes.

### BRIEF DESCRIPTION OF DRAWINGS

FIGS. 1A and 1B are photographs comparing representative agglomerates of the present invention in comparison to an assortment of typical commercial agglomerates;

FIG. 2 is a process diagram for Agglomerate production of the present invention;

FIG. 3 is a graphical representation of the results from an experiment carried out to demonstrate a texture comparison of sweet agglomerates incorporating various binding matrix formulations;

FIG. 4 is a graphical representation of the results from an experiment carried out to demonstrate a texture comparison of sweet agglomerates incorporating various levels of binding matrix, water, oil, and shortening;

FIG. 5 is a graphical representation of the results of a first set of experiments carried out to demonstrate a texture comparison between the agglomerate of the invention and a commercially-available agglomerate;

FIG. 6 is a graphical representation of the results of a second set of experiments carried out to demonstrate a texture comparison between the agglomerate of the invention and a commercially-available agglomerate;

FIG. 7 is a graphical representation of the results of a third set of experiments carried out to demonstrate a texture comparison between the agglomerate of the invention and commercially-available agglomerate, and

FIG. 8 is a graphical representation of the results of a set of experiments carried out to demonstrate the attrition resistance of the agglomerate of the present invention in comparison to commercially-available agglomerate.

### GENERAL DESCRIPTION OF THE INVENTION

The agglomerates provided herein comprise particulate cereals, such as flakes, held together by a starch-based binding matrix. The starch-based binding matrix may be present in an amount of about 5 to about 20 wt % of the overall agglomerate depending on the ingredient formulation. The matrix binds together the components of the agglomerate and does not have an adverse affect on the flavour or appearance of the agglomerated material. This allows for the formulation of agglomerates with limited sugar content, thus increasing the range of flavours and their application potential. The textural properties and appearance of the agglomerates can be controlled through manipulation of matrix formulation and/or process conditions.

Starches utilized in connection with the agglomerates are ones which thicken quickly without cooking and are fully incorporated into the agglomerate mixture after a short mixing time. The binding matrix which is present in the product agglomerates exhibits no visible presence following heating to dry the extruded agglomerates.

In addition to starch, the binding matrix may include proteins, sugars, gums, and oils to alter the properties of the agglomerates, such as cohesive strength, hardness, crunchiness, flavour, and chewiness.

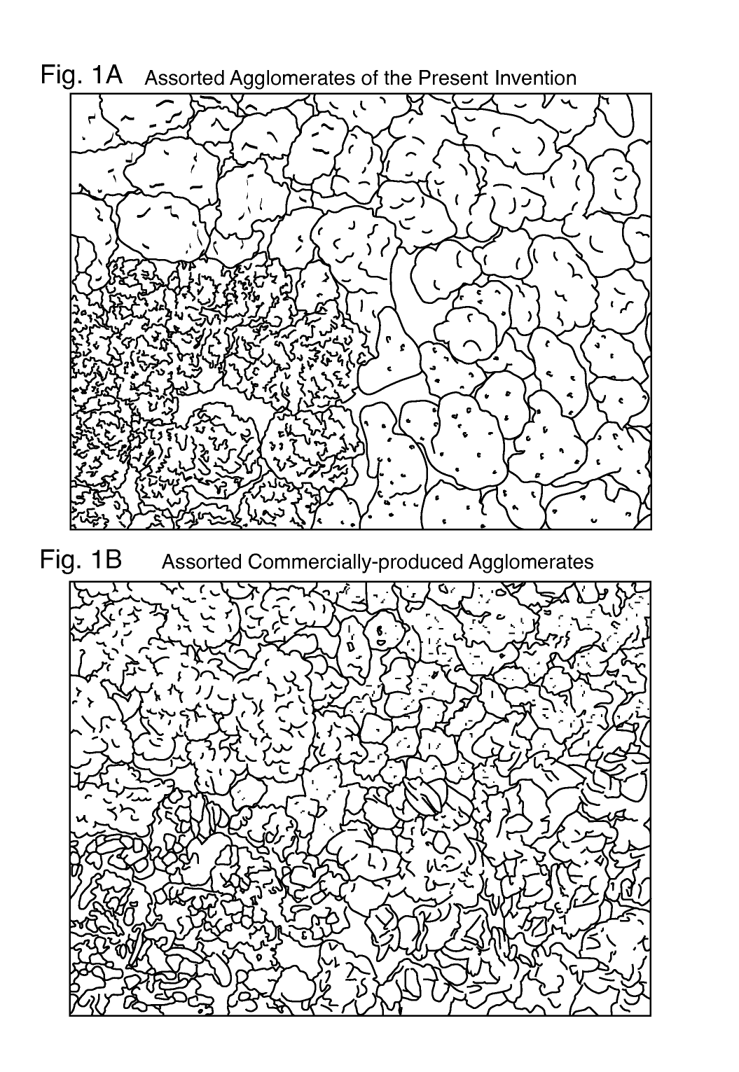

The appearance of the agglomerates of the present invention is shown in FIG. 1A, contrasted against existing commercially available agglomerates in FIG. 28.

The agglomerates provided herein typically range from about 2 mm to12 mm in their largest dimension with a bulk density from about 0.3 cm³ to about 0.5 cm³. Their moisture content may range from about 3% to about 8%.

Depending on formulation and processing conditions, the agglomerates can be altered significantly in appearance from distinctive, irregularly shaped particulates to more homogenous, uniformly shaped pieces. The agglomerates can possess a wide variety of colours and flavours.

The agglomerates have desirable textural characteristics of crunchiness and fracturability. The agglomerates exhibit a peak resistance to compression of about 10 to about 20 kg of force, with a total resistance of about 5 to about 10 kg s, as measured by a Stable Microsystems Texture Analyzer XT2i equipped with a 12.5 mm acrylic cylindrical probe.

The agglomerates possess enhanced attrition resistance, allowing them to be utilized in a variety of further processing, such as the addition of topical seasonings, “all-in-one” inclusions for cereal bar manufacturers, or as components in coating systems for batter/breaded systems. The ability to add topical seasonings without significantly altering the granulation profile of the agglomerate allows for efficient use of generic agglomerate bases that can be seasoned to accommodate a wide range of flavour profiles.

A variety of different agglomerates may be provided in accordance with the invention. Some typical dry mix formulations from which the agglomerates may be formed are set forth in the following Tables 1 and 2:

TABLE 1
Sweet Agglomerate Formulation Ranges

| Ingredient | wt % |
|---|---|
| Cereal Flakes | about 60 to about 70 |
| Sugar | about 10 to about 20 |
| Inclusions (Seeds, berries, etc.) | about 5 to about 10 |
| Binding Matrix | about 6 to about 9 |
| Oil | about 3 to about 5 |
| Flavour | <5 |
| Salt | <1 |

TABLE 2
Savory Agglomerate Formulation Ranges

| Ingredient | wt % |
|---|---|
| Cereal Flakes | about 50 to about 60 |
| Binding Matrix | about 10 to about 18 |
| Inclusions (Seeds, berries, etc.) | about 5 to about 10 |
| Oil | about 3 to about 5 |
| Sugar | about 1 to about 5 |
| Flavour | about 1 to about 5 |
| Leavening | <3 |
| Salt | <1 |

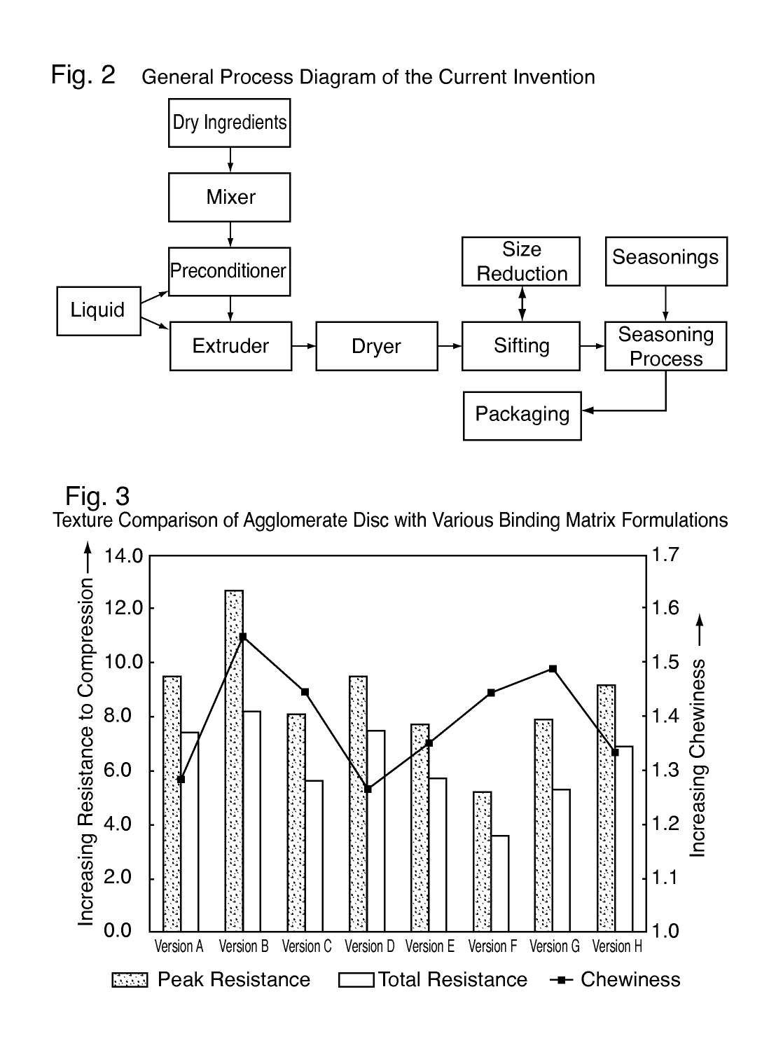

The general process to produce agglomerates according to the present invention is shown in FIG. 2. The dry ingredients including the binding matrix component at about 5 to about 15 wt % is blended together in a mixer. The blended mixture then is fed to a preconditioner of an extruder where water and/or steam may be added, typically between about 5 and about 10 wt % of the dry feed rate. The amount of moisture added to the agglomerate mixture should be sufficient to hydrate the binding matrix, allowing it to swell and form a paste to bind the bulk components together during the extrusion process. The resulting blend is then passed through an extruder, where additional water and other liquid components may be added. The extruder uses a relatively open die, or is open ended, so that the back pressure and heat generated in the extruder are sufficient to permit the matrix material to bind the particulate cereal without excessive shear to compromise the structure of the agglomerate. The heat generated may be controlled by cooling the extruder so that the composition is not cooked during passage through the extruder. The process conditions employed depend on the specific form of extruder employed.

Following extrusion through the die, the formed agglomerates are cut into pieces of a desired size, which are then conveyed to a dryer where they are dried or toasted to the desired final moisture content under typical drying conditions. Some agglomerates may undergo a topical seasoning process after drying.

The extruder may be typically operated in accordance with the parameters outlined in the following Tables 3 and 4.

TABLE 3
Process Parameter Range for Wenger TX-144 Mag
ST Extruder, Model 32A DDC Conditioning Cylinder
(Patented) to Produce Agglomerates

| Parameter | Description/Range |
|---|---|
| Die Size × # Holes | Open; ⅜″ × 64; ½″ × 84 |
| Water (Preconditioner/Extruder) | 15-20% of Dry Feed Rate |
| Extruder RPM | 200-300 |
| Extrusion Temperature | 40-70° C. |
| Pressure | 100-1200 kPa |
| Knife Setup | 1-2 Blade(s) × 500-1000 RPM |
| Drying | 5-8 min @ 150-160° C. |

TABLE 4
Process Parameter Range for Extru-Tech E525
5-Head Extruder to Produce Agglomerates

| Parameter | Description/Range |
|---|---|
| Die Size × # Holes | ½″ × 9; ⅜″ × 9 |
| Water (Extruder Barrel) | 13-19% of Dry Feed Rate |
| Extruder RPM | 70 |
| Extrusion Temperature | 30-50° C. |
| Knife Setup | 2 Blades × 300-750 RPM |
| Drying | 8-10 min @ about 150-165° C. |

### EXAMPLES

### Example 1

This Example demonstrates the textural attributes of a standardized sweet agglomerate disc held together by different formulations of binding matrix.

Texture analysis was performed using a Stable Microsystems TA-XT2i Texture Analyser equipped with a 12.5 mm acrylic cylindrical probe. Agglomerate discs were standardized to a 10 mm height and 20 mm diameter. The agglomerate disc mixture contained 5 wt % oil and 20 wt % water, and was dried to 4-5 wt % moisture.

In the following data, the “peak resistance” is the maximum force encountered by the texture analyzer probe when compressing the samples. The “total resistance” is the total force applied through the duration of the test. The “chewiness” is the ratio of the peak resistance to total resistance. Chewier agglomerates resist fracture longer, but require less overall force to compress. Values of around 1.5-2.0 are typically crunchy and fracturable, without being considered too hard, while values over 3 indicate softer, chewier agglomerates.

The textural effects of binding matrix formulation described in Table 5 are shown in Table 6 and graphically represented in FIG. 3.

TABLE 5
Binding Matrix Formulations

| | Instant | Instant | Instant | | | | | |
|---|---|---|---|---|---|---|---|---|
| | Chem. | Chem. | Mech. | | | | | |
| | Modified | Modified | Modified | | | | Methyl- | |
| Matrix | Corn | Wheat | Corn | Malto- | Tapioca | | cellulose | Xanthan |
| Version | Starch | Starch | Starch | dextrin | Dextrin | Pea Protein | Gum | Gum |
| A | 100% | | | | | | | |
| B | 60% | | | 40% | | | | |
| C | 60% | | | | 40% | | | |
| D | 90% | | | | | 10% | | |
| E | 90% | | | | | | 10% | |
| F | | 100% | | | | | | |
| G | | | 100% | | | | | |
| H | 90% | | | | | | | 10% |

TABLE 6
Texture Comparison of Binding Matrix Blends at 10 wt %

| Binding Matrix | Peak | Total | |
|---|---|---|---|
| Version | Resistance, kg | Resistance, kg s | Chewiness |
| Version A | 9.5 | 7.4 | 1.3 |
| Version B | 12.7 | 8.2 | 1.5 |
| Version C | 8.1 | 5.6 | 1.4 |
| Version D | 9.5 | 7.5 | 1.3 |
| Version E | 7.7 | 5.7 | 1.4 |
| Version F | 5.2 | 3.6 | 1.4 |
| Version G | 7.9 | 5.3 | 1.5 |
| Version H | 9.2 | 6.9 | 1.3 |

At 100% of the binding matrix formulation A, a chemically modified instant corn starch, imparted more desirable textural properties and strength to the agglomerate disc then two alternative starches, an instant chemical modified wheat starch (version F) and an instant mechanically modified wheat starch (version G). For this reason, it was chosen as the base binding matrix component.

The addition of corn maltodextrin (version B) provided a synergistic effect to the starch's performance, improving its dispersion through the agglomerate mixture and improving the binding matrix. Additional testing did show that at levels above 40% in the matrix, the presence of the maltodextrin started to decrease the binding strength of the matrix. A tapioca dextrin (version C) did not perform as well at the same 40% level.

The addition of pea protein (version D), Methylcellulose (version E) or Xanthan gum (version H), did not have a significant impact on the agglomerate's textural properties as measured by the texture analyzer. However, version D and version H, did impart a noticeably crispier texture to the agglomerate disc.

### Example 2

This Example illustrates the textural attributes of a standardized agglomerate disc with varying levels of binding matrix, water, oil, and shortening.

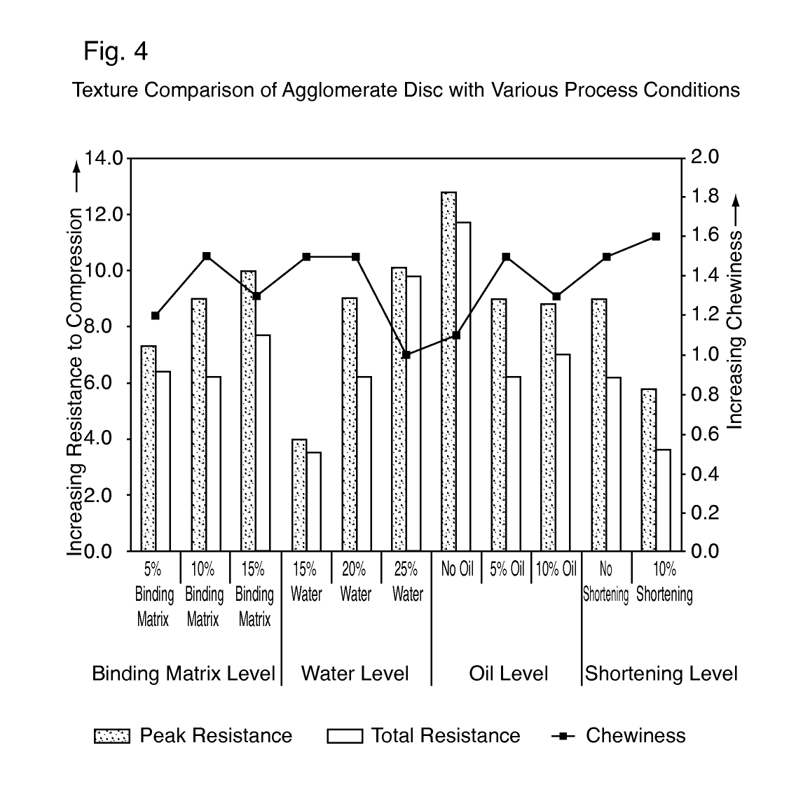

Texture analysis conducted as described in Example 1, with exception to formulation modifications as shown in Table 7. A graphical representation is given in FIG. 4.

TABLE 7
Texture Comparison of Process

| Process | | Peak | Total | |
|---|---|---|---|---|
| Parameter | | Resistance, kg | Resistance, kg s | Chewiness |
| Binding | 5 wt % | 7.3 | 6.4 | 1.2 |
| Matrix Level | 10 wt % | 9.0 | 6.2 | 1.5 |
| | 15 wt % | 10.0 | 7.7 | 1.3 |
| Water Level | 15 wt % | 5.1 | 3.5 | 1.5 |
| | 20 wt % | 9.0 | 6.2 | 1.5 |
| | 25 wt % | 10.1 | 9.8 | 1.0 |
| Oil Level | None | 12.8 | 11.7 | 1.1 |
| | 5 wt % | 9.0 | 6.2 | 1.5 |
| | 10 wt % | 8.8 | 7.0 | 1.3 |
| Shortening | None | 9.0 | 6.2 | 1.5 |
| Level | 10 wt % | 5.8 | 3.6 | 1.6 |

In the present Example, version A of the binding matrix was used. Increasing the binding matrix resulted in stronger agglomerates. At lower levels, the quantity of the binding matrix becomes insufficient to bind together the agglomerate components. High levels of binding matrix typically results in denser and/or harder agglomerates with unfavourable textural attributes. The relationship between the binding matrix level and texture of the agglomerate is not linear.

Water level has a significant effect on texture and agglomerate resiliency. Low levels of water result in poor hydration of binding matrix in the agglomerate mixture, resulting in poorly formed agglomerates. Increasing the water content improves the performance of the binding matrix by improving the dispersion and hydration of the binding matrix. However, higher water levels become undesirable as it increases the required drying time for the agglomerates.

The addition of sunflower oil can be seen to soften the agglomerate significantly, but the strength of the effect quickly diminishes as the level of oil added surpasses 5 wt %.

The addition of palm oil shortening at 10 wt % significantly altered the texture of the agglomerate, resulting in a much softer and increasingly chewier piece, but did not compromise the cohesive strength of the agglomerate. The textural effect of the shortening was more pronounced than with the equivalent wt % of oil.

### Example 3

This Example illustrates the production of sweet agglomerates according to the present invention.

Sweet agglomerates were produced from dry mixes having the formulation shown in Table 8 below using the Wenger TX-144 Extruder operating in accordance with the ranges of operating parameters given in Table 9.

TABLE 8
Sweet Agglomerate Formulation

| Ingredient | % |
|---|---|
| Granola Oats | 69.0 |
| Sugar | 16.0 |
| Binding Matrix Version G | 7.5 |
| Sunflower Oil | 5.0 |
| Flavour | 2.0 |
| Salt | 0.5 |
| Total | 100.0 |

TABLE 9
Process Parameters for Wenger TX-144 Extruder
to Produce Sweet Agglomerates

| Parameter | Description/Range |
|---|---|
| Die Size × # Holes | ½″ × 84 |
| Water (Preconditioner/Extruder) | 15-20% of Dry Feed Rate |
| Extruder RPM | 200-300 |
| Extrusion Temperature | 40-60° C. |
| Pressure | 500-1000 kPa |
| Knife Setup | 1 Blade × 600-1000 RPM |
| Drying | 5-8 min @ 150-160° C. |

The dry mixes were blended prior to entering the feed system of the extruder. The dry feed rate was 1500 kg/h and water addition was split between the pre-conditioning cylinder and the extruder. The resulting agglomerates were dried to a moisture content of about 3 to 5 wt %.

Increased water addition or increased extruder RPM contributed to a more homogenous product with less distinct oat pieces which had greater tackiness. A tacky agglomerate is generally undesirable for process handling, particularly in systems utilizing pneumatic conveyance. An increased proportion of water added in the precondition in relation to the water added to the extruder barrel reduced breakage of the agglomerates and provided more distinct agglomerates. Adjusting the cutting knife speed allowed for coarse control of agglomerate size and shape.

The majority of the sweet agglomerates ranged from 2 to 12 mm in size with an average bulk density of 0.41 g/cm³.

### Example 4

This Example illustrates the production of savory agglomerates in accordance to the invention.

The procedure of Example 3 was repeated using dry mixes having the formulation given in Table 10 below and having the process conditions specified in Table 11.

TABLE 10
Savory Agglomerate Formulation

| Ingredient | % |
|---|---|
| Granola Oats | 69.6 |
| Binding Matrix Version B | 18.0 |
| Sunflower Oil | 5.0 |
| Sugar | 4.7 |
| Sodium Bicarbonate/Sodium Acid | 2.4 |
| Pyrophosphate | |
| Flavour | 0.3 |
| Total | 100.0 |

The binding matrix included maltodextrin, an alternative soluble ingredient, to improve its dispersion within the dry blend. This replaced the higher level of sugar employed in Example 3. The leavening was used to aid in providing a crispy texture in the absence of the high level of sugar used in Example 3.

TABLE 11
Process Parameters for Wenger TX-144 Extruder
to Produce Savory Agglomerates

| Parameter | Description/Range |
|---|---|
| Die Size × # Holes | No Die or ½″ × 84 |
| Water (Preconditioner/Extruder) | 20-25% of Dry Feed Rate |
| Extruder RPM | 250-300 |
| Extrusion Temperature | 40-60° C. |
| Pressure | 100-200 kPa |
| Knife Setup | 1 Blade × 750-1000 RPM |
| Drying | 5-8 min @ 150-160° C. |

The dry feed rate ranged from 1500 to 2000 kg/hr and water addition was split unevenly between the pre-conditioner and the extruder barrel in a 2:1 ratio.

The removal of the die constriction resulted in desirable random, flake shaped agglomerates with enhanced cereal particle integrity. Crispness was enhanced by developing a leavened pore structure, thus reducing the particle density.

The savory agglomerates ranged from 2 to 12 mm in size with an average bulk density of 0.33 g/cm³.

### Example 5

This Example illustrates the provision of seasoned savory agglomerates.

A size-specific fraction (6 to 12mm) of savory agglomerates produced as described in Example 4 was obtained via a rotex sifter and was formed into seasoned savory agglomerates in accordance with the formulation set forth in Table 12.

TABLE 12
Savory Agglomerate, Seasoned, Formulation

| Ingredient | % |
|---|---|
| Savory Agglomerates | 85.0 |
| Smoked Chili Seasoning | 6.0 |
| Palm Oil Shortening | 9.0 |
| Total | 100.0 |

The sized agglomerates were transferred to a seasoning line where shortening and seasoning mix were applied to the agglomerates s they passed through a rotating drum. Only a very small change in granulation was observed with 2% fine pieces (<2 mm) generated through the seasoning process.

### Example 6

This Example illustrates the production of sweet booster agglomerates.

The procedure of Example 3 was again repeated to prepare sweet booster agglomerates from dry mixes having the formulation set forth in Table 13 below using the process conditions set forth in Table 14 below. The term “booster” refers to formulating with significant amounts of health promoting ingredients such as fibre, inulin, and 13-glucan. Again, leavening was added to improve textural characteristics.

TABLE 13
Sweet Booster Agglomerate Formulation

| Ingredient | % |
|---|---|
| Granola Oats/Barley Flakes | 59.2 |
| Binding Matrix Version B | 11.3 |
| Sugar | 8.0 |
| Milled Flax Seed | 5.2 |
| Sunflower Oil | 5.0 |
| Inulin | 4.0 |
| Pea Fibre | 3.3 |
| Sodium Bicarbonate/Sodium Acid | 2.4 |
| Pyrophosphate | |
| Barley Beta Glucan | 1.0 |
| Salt | 0.4 |
| Flavour | 0.2 |
| Total | 100.0 |

TABLE 14
Process Parameters for Wenger TX-144 Extruder
to Produce Sweet Booster Agglomerates

| Parameter | Description/Range |
|---|---|
| Die Size × # Holes | No Die |
| Water (Preconditioner/Extruder) | 18-21% of Dry Feed Rate |
| Extruder RPM | 225-250 |
| Extrusion Temperature | 40-60° C. |
| Pressure | 200-300 kPa |
| Knife Setup | 1 Blade × 1000 RPM |
| Drying | 6-8 min @ 155-165° C. |

The dry feed rate was 2000 kg/hr and water addition was split unevenly between the preconditioner and extruder barrel in a 2:3 ratio.

The use of an open-ended extruder produced sweet booster agglomerates with a desirable, random shaped appearance. The higher percentage of soluble ingredients in the mix, particularly soluble fibre, increased drying time of the agglomerates. In this trial, the presence of such ingredients necessitated the use of higher water levels through the extruder barrel, rather than through the pre-conditioner, to enhance cereal flake integrity and impart lighter texture. The majority of agglomerates ranged from 2 to 12 mm in size and had a bulk density of 0.37 g/cc.

### Example 7

This Example illustrates the preparation of cranberry agglomerates according to the present invention.

Example 1 was repeated to form cranberry agglomerates using an Extru-Tech E525 5-head Extruder in place of Wenger TX-144 Extruder and using a dry mix having the formulation shown in Table 15 below utilizing the operating parameters shown in Table 15 below. The dry feed rate was 180 kg/hr and water was added only to the extruder barrel.

TABLE 15
Cranberry Agglomerate Formulation

| Ingredient | % |
|---|---|
| Barley Flakes | 30.8 |
| Granola Oats | 30.8 |
| Sugar | 18.0 |
| Binding Matrix Version A | 8.0 |
| Cranberry Pieces | 6.0 |
| Sunflower Oil | 5.0 |
| Malic Acid | 0.7 |
| Flavour/Colour | 0.7 |
| Total | 100.0 |

TABLE 16
Process Parameter Range for Extru-Tech E525
Extruder to Produce Cranberry Agglomerates

| Parameter | Description/Range |
|---|---|
| Die Size × # Holes | ½″ × 9 |
| Water (Extruder Barrel) | 14-15% of Dry Feed Rate |
| Extruder RPM | 70 |
| Extrusion Temperature | 30-50° C. |
| Knife Setup | 2 Blades × 330 RPM |
| Drying | 8-10 min @ 150-160° C. |

The lower RPM and less aggressive configuration of the Extru-Tech E525 extruder produced agglomerates with greater visual differentiation in comparison to agglomerates produced on the Wenger TX-144 extruder. The reduced knife speed produced larger pieces with a more rounded appearance. Additional drying time was required due to the use of a smaller commercial oven than was the case in the above Examples, which used a larger industrial dryer.

The cranberry pieces provided a strong visual and flavour contrast to the Granola/Barley base. The agglomerates were typically sized 6 to 12 mm and had an average bulk density of 0.41 g/cc.

### Example 8

This Example compares the performance of the agglomerate prepared as described in the foregoing Examples with commercially-available agglomerates.

Commercial agglomerate type 1 was produced in a typical drum process. Commercial agglomerate type 2

### (a) Hot Cereal Application

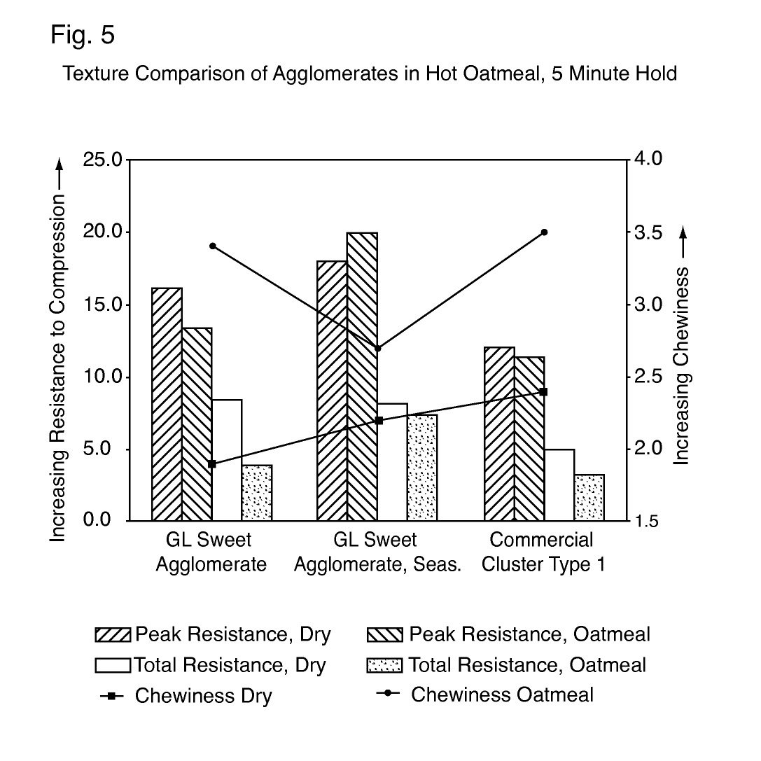

Agglomerates were stirred into oatmeal after it had been hydrated by hot water (80° to 85° C.) and the resulting mixture held for five minutes. The results obtained are shown in the following Table 17 and in FIG. 5.

TABLE 17
Texture Comparison, Hot Oatmeal, Topical Addition, 5 Minute Hold

| | Peak | | Total | | | |
|---|---|---|---|---|---|---|
| | Resistance, | | Resistance, | | | |
| | kg | | kg s | | Chewiness | |
| Product | Before | After | Before | After | Before | After |
| Sweet Agglomerate | 16.1 | 13.4 | 8.4 | 3.9 | 1.9 | 3.4 |
| (Example 3) | | | | | | |
| Sweet Agglomerate, | 18.0 | 19.9 | 8.1 | 7.3 | 2.2 | 2.7 |
| Seasoned | | | | | | |
| Commercial | 12.1 | 11.4 | 5.0 | 3.3 | 2.4 | 3.5 |
| Agglomerate Type 1 | | | | | | |

As may be seen from the data in Table 10, the seasoned sweet agglomerates maintained their overall texture with a slight increase in chewiness. The unseasoned sweet agglomerates of Example 3 were equivalent to the commercially-available agglomerate in terms of texture after holding. The advantage of being able to add topical seasonings without altering the general agglomerate appearance provides additional barriers to moisture migration, maintaining the agglomerate's texture for a longer period of time.

### (b) Cold Cereal Application

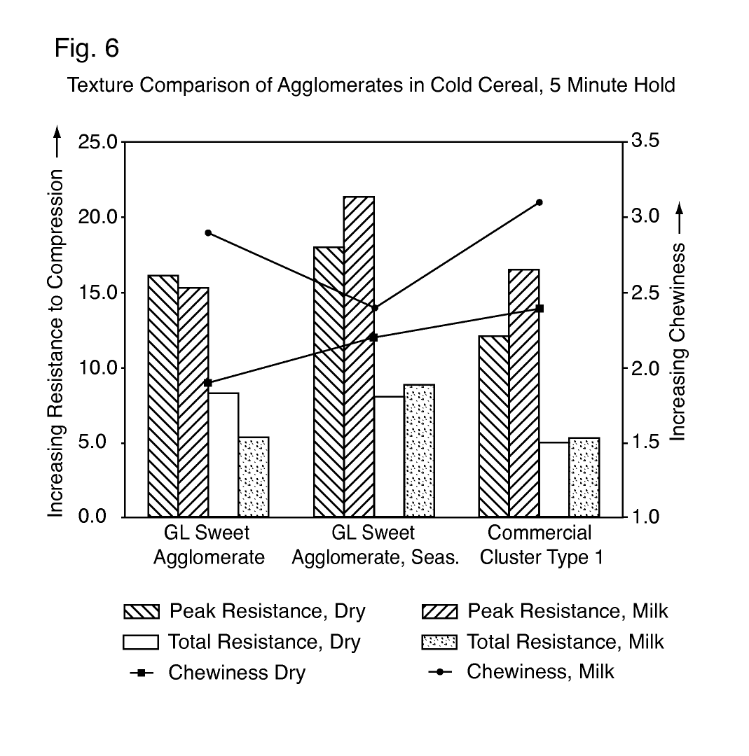

Agglomerates were stirred into cold milk and held for five minutes. The results obtained are shown in the following Table 18 and FIG. 6.

TABLE 18
Texture Comparison, Immersion in Cold Milk, 5 Minute Hold

| | Peak | | Total | | | |
|---|---|---|---|---|---|---|
| | Resistance, | | Resistance, | | | |
| | kg | | kg s | | Chewiness | |
| Product | Before | After | Before | After | Before | After |
| Sweet Agglomerate | 16.1 | 15.3 | 8.4 | 5.3 | 1.9 | 2.9 |
| (Example 3) | | | | | | |
| Sweet Agglomerate, | 18.0 | 12.3 | 8.1 | 8.8 | 2.2 | 2.4 |
| Seasoned | | | | | | |
| Commercial | 12.1 | 16.5 | 5.0 | 5.3 | 2.4 | 3.1 |
| Agglomerate Type 1 | | | | | | |

Similar to the hot cereal application, the seasoned sweet agglomerates of Example 3 maintained their overall texture with only a slight increase in chewiness. The unseasoned sweet agglomerates of Example 1 were equivalent to the commercial agglomerate.

### (c) Baked Goods Application

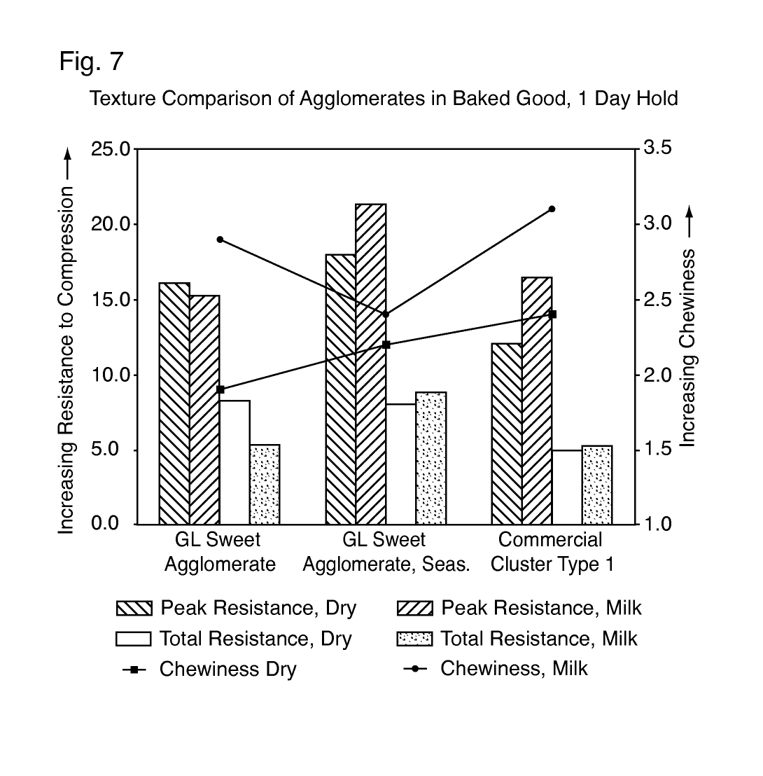

Agglomerates were topically added to a hydrated muffin mix prior to baking. The baked muffins were allowed to set for a full day before texture analysis was performed on the agglomerates. The data generated appear in Table 19 below and FIG. 7.

TABLE 19
Texture Comparison, Topical Addition for Baked Muffin, 1 Day Hold

| | Peak | | Total | | | |
|---|---|---|---|---|---|---|
| | Resistance, | | Resistance, | | | |
| | kg | | kg s | | Chewiness | |
| | Before | After | Before | After | Before | After |
| Sweet Agglomerate | 16.1 | 15.3 | 8.4 | 12.3 | 1.9 | 1.9 |
| (Example 3) | | | | | | |
| Sweet Agglomerate, | 18.0 | 21.3 | 8.1 | 11.8 | 2.2 | 2.0 |
| Seasoned | | | | | | |
| Savory Agglomerate | 13.0 | 12.7 | 5.8 | 7.3 | 2.2 | 1.7 |
| (Example 4) | | | | | | |
| Savory Agglomerate, | 16.6 | 11.8 | 6.5 | 6.0 | 2.5 | 2.0 |
| Seasoned (Example 5) | | | | | | |
| Commercial | 12.1 | 11.3 | 5.0 | 4.1 | 2.4 | 2.7 |
| Agglomerate Type 1 | | | | | | |
| Commercial | 14.7 | 11.9 | 5.1 | 4.7 | 2.9 | 2.5 |
| Agglomerate Type 2 | | | | | | |

Both the sweet and savory agglomerates of the present invention retained or improved on their crunchy texture while the two commercially-available clusters became slightly softer and chewier. As inclusions in a muffin mix, agglomerates of the present invention retained their integrity, while the commercial agglomerates were broken down during the baking process and incorporated into the muffin matrix as non-descript pieces of oat.

### Example 9

This Example illustrates the attrition resistance of the agglomerates of the present invention in comparison to commercially-available agglomerates.

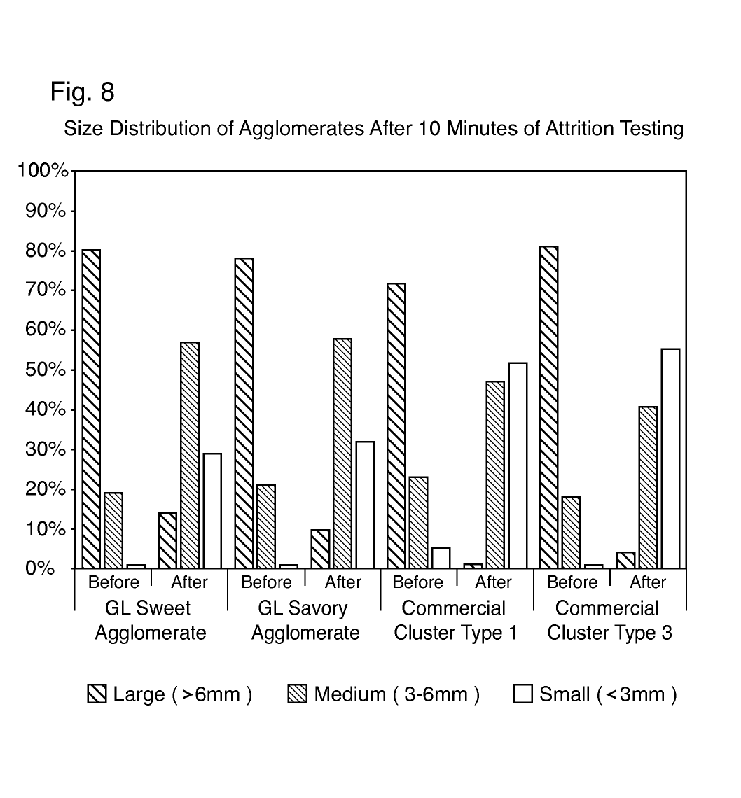

Sweet and savory agglomerates, prepared as described in Examples 3 and 4, as well as two commercially-available agglomerates were continuously blended in a KitchenAid Profession Mixer (350W) with the paddle attachment at high speed for 10 minutes. The results obtained are shown in Table 13 below and FIG. 8.

TABLE 20
Size Distribution of Agglomerates after 10 Minutes of Attrition Testing

| | | | | | Commercial | | Commercial | |
|---|---|---|---|---|---|---|---|---|
| | Sweet | | Savory | | Agglomerate | | Agglomerate | |
| | Agglomerate | | Agglomerate | | Type 1 | | Type 3 | |
| Size | Before | After | Before | After | Before | After | Before | After |
| Large (>6 mm) | 80% | 14% | 78% | 10% | 72% | 1% | 81% | 4% |
| Medium (3-6 mm) | 19% | 57% | 21% | 58% | 23% | 47% | 18% | 41% |
| Small (<3 mm) | 1% | 29% | 1% | 32% | 5% | 52% | 1% | 55% |

As can be seen from the data in Table 13, compared to commercially-available agglomerates, the agglomerates of the invention retained significantly more large and medium sized particles and generated fewer small pieces (fines) compared to the commercial products, thereby exhibiting greater attrition resistance. The breakdown of the commercial agglomerates tended to result in individual agglomerate components such as oat flake or crisp rice, where agglomerates of the present invention typically remained similar in general appearance to their initial state.

### SUMMARY OF THE DISCLOSURE

In summary of this disclosure, agglomerates of cereals in a binding matrix are prepared by extrusion under mild conditions followed by drying. Modifications are possible within the scope of the invention.

1.-10. (canceled)

11. A process of preparing a food agglomerate, which comprises;
dry blending a mixture of particulate cereal and a starch-based binding matrix,
adding water to the blend in sufficient amount to hydrate the binding matrix,
extruding the resulting mixture to an outlet while generating sufficient heat to permit the matrix material to bind the particulate cereal but insufficient to cook or toast the particulate cereal,
cutting the extruded agglomerates into pieces of a desired size, and
drying the agglomerate pieces.

12. The process of claim 11 wherein said water is added to the blend when located in a preconditioner to the extruder, the barrel of the extruder, or split between the preconditioner and barrel.

13. The process of claim 12 wherein said preconditioner and extruder are operated under the following conditions and parameters:

| Parameter | Description/Range |
|---|---|
| Die Size × # Holes | Open; ⅜″ × 64; ½″ × 84 |
| Water (Preconditioner/Extruder) | 15-20% of Dry Feed Rate |
| Extruder RPM | 200-300 |
| Extrusion Temperature | 40-70° C. |
| Pressure | 100-1200 kPa |
| Knife Setup | 1-2 Blade(s) × 500-1000 RPM |
| Drying | 5-8 min @ 150-160° C. |

14. The process of claim 12 wherein said preconditioner and extruder are operated under the following conditions and parameters:

| Parameter | Description/Range |
|---|---|
| Die Size × # Holes | ½″ × 9; ⅜″ × 9 |
| Water (Extruder Barrel) | 13-19% of Dry Feed Rate |
| Extruder RPM | 70 |
| Extrusion Temperature | 30-50° C. |
| Knife Setup | 2 Blades × 300-750 RPM |
| Drying | 8-10 min @ about 150-165° C. |
